(19) United States
(12) Patent Application Publication
(10) Pub. No.: US 2008/0053167 A1
(43) Pub. Date: Mar. 6, 2008

(54) Textual combination locking devices and methods

(75) Inventor: Todd Basche, Los Altos, CA (US)

Correspondence Address: PERKINS COIE LLP;PATENT-SEA, P.O. BOX 1247, SEATTLE, WA, 98111-1247, US

(73) Assignee: Wordlock, LLC, Los Altos, CA (US)

(21) Appl. No.: 11/710,245

(22) Filed: Feb. 23, 2007

Related U.S. Application Data
(60) Provisional application No. 60/824,446, filed on Sep. 3, 2006.
(60) Provisional application No. 60/824,447, filed on Sep. 3, 2006.

(51) Int. Cl. E05B 37/02; B23P 17/00

(52) U.S. Cl. 70/22; 29/592

(57) ABSTRACT

A word-based combination locking device comprising a body, a locking mechanism and a plurality of wheels. The wheels rotate relative to the body and locking mechanism and display a plurality of letters across the device. The wheels and the letters are configured to simultaneously spell two or more words across the device.

### CROSS REFERENCE TO RELATED APPLICATIONS

This application claims the benefit of U.S. Provisional Patent Application Nos. 60/824,446 and 60/824,447, filed Sep. 3, 2006, which are incorporated herein by reference.

### TECHNICAL FIELD

The present invention relates to combination locking devices having textual combinations.

### BACKGROUND

Locks are commonly used for securing a wide variety of objects. For instance, locks are frequently used to secure lockers, toolboxes, luggage, bags, gates, doors, containers, bicycles, vehicles and the like. One main disadvantage of a key-based lock is that a physical key is required to open the lock. Another disadvantage of a key-based lock is that a user typically cannot reset or change the key configuration without also replacing the lock.

Combination locks overcome many of the disadvantages of key-based locks by providing a numeric combination instead of a physical key to open the lock. Two common types of numeric combination-based locks are rotary-style and tumbler-style locks. Rotary-style locks generally have a rotating dial that displays a range of numbers, while tumbler-style locks generally have three to five tumblers or wheels displaying the numbers 0-9. However these numeric combination-based locks also have many disadvantages. For example, the numeric combination to open the lock is often preset by the manufacturer of the lock. Accordingly, a user is forced to learn an unrelated or random numeric sequence that may be difficult to remember. In addition, even if a user may reset or customize the may reset or customize the numeric combination, many users simply have trouble remembering numeric combinations. With a combination lock, if the user forgets the numeric combination the user must typically destroy the lock to open and remove the lock, which can be inconvenient and expensive. Furthermore, as noted above, tumbler-style combination locks typically only display ten numbers (0-9) per tumbler, thereby limiting the overall number of available combinations.

U.S. Pat. No. 6,621,405, which is incorporated herein in its entirety by reference, addresses many of these disadvantages of numeric combination locks by providing a customizable combination lock using a single word for the combination that opens the lock, as well as methods of optimizing the number of word combinations for the lock. However the lock and method disclosed in this patent are only capable of providing a one word combination to open the lock that is limited to ten letter positions (corresponding to the numbers 0-9). Accordingly, a need exists to provide textual combination locks allowing for an increased number and variety of displayed word combinations that are easier for the user to remember.

### SUMMARY

The present disclosure overcomes challenges and limitation of the prior art and provides additional benefits. A brief summary of several embodiments and aspects of the invention are presented. Thereafter, a detailed description of the illustrated embodiments is presented, which will permit one skilled in the relevant art to understand, make and use the invention. One skilled in the art can obtain a full appreciation of aspects of the invention from the subsequent detailed description, read together with the Figures, and from the claims, which follow the Detailed Description.

In one embodiment of the invention, a word-based combination locking device is provided that comprises a body and a locking mechanism coupled to the body. At least two wheels are operatively coupled to the locking mechanism and to the body. Each of the wheels is rotatable relative to the body between a locked positions wherein the locking mechanism is locked relative to the respective wheel, and an unlocked position wherein the locking mechanism is unlocked relative to the respective wheel. Each of the wheels displays two or more letters forming two or more rows of letters relative to the body. The letters on the wheels are configured to spell a first word displayed on the first row of letters and a second word displayed on the second row of letters.

In another embodiment of the invention, a word based combination locking device is provided that comprises a body and a locking mechanism operatively coupled to the body. A plurality of wheels are operatively coupled to the locking mechanism and to the body. Each of the wheels has a plurality of letters that can be arranged to form two or more rows of letters relative to the body. The wheels are rotatable relative to the locking mechanism in a locked position and an unlocked position, and the letters can be arranged to simultaneously spell at least two words in the two or more rows. At least one of the two or more words is a word in a language other than English.

In yet another embodiment, a method of manufacturing a word-based combination locking device comprises selecting a plurality of words to be displayed by the device and disposing a plurality of rotatable wheels at least partially within the device. The wheels display a plurality of letters that are configured to spell words across the device. The method further includes arranging the plurality of wheels in a first position. In the first position the wheels simultaneously display a first combination of two or more of the plurality of words.

### BRIEF DESCRIPTION OF THE DRAWINGS

FIG. 1 is a schematic view of a customizable text-based locking device in accordance with an embodiment of the invention.

FIG. 2 is a block diagram of a representative table illustrating letter positions of the wheels in accordance with embodiments of the invention.

FIG. 3 is a schematic view of a text-based locking device in accordance with another embodiment of the invention.

FIGS. 4A and 4B are schematic views of text-based locking devices in retail packaging in accordance with other embodiments of the invention.

FIGS. 5A-5C are schematic views of text-based locking devices in accordance with other embodiments of the invention.

### DETAILED DESCRIPTION

Textual combination locks, including word-based combination locks, are described in detail herein in accordance with embodiments of the present invention. Word-based combination locks include but are not limited to locks for securing lockers, toolboxes, luggage, bags, gates, doors, containers, bicycles, vehicles and the like. In the following description, numerous specific details are discussed to provide a thorough and enabling description for embodiments of the invention. One skilled in the relevant art, however, will recognize that the invention can be practiced without one or more of the specific details. In other instances, well-known structures or operations are not shown, or are not described in detail to avoid obscuring aspects of this invention. In general, alternatives and alternate embodiments described herein are substantially similar to the previously described embodiments, and common elements are identified by the same reference numbers.

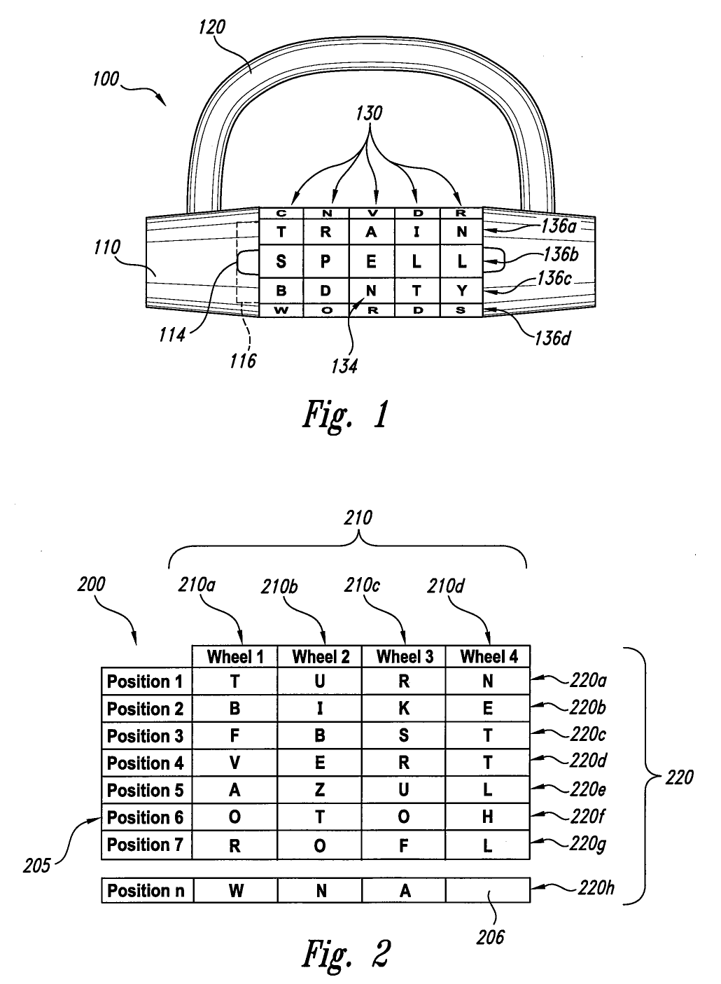

FIG. 1 is a schematic view of a text-based combination locking device 100 in accordance with at least one embodiment. The device 100 is manipulatable between locked and unlocked positions, and includes tumblers or wheels 130 displaying letters configured to simultaneously spell two or more words when the locking device is in the locked or unlocked positions. In one embodiment, the locking device 100 includes a body 110, a locking mechanism 120 and a plurality of the rotatable wheels 130. The body 110 houses the internal lock components (not shown) of the locking device 100. The locking member 120 is operatively coupled to the body 110 such that the locking member 120 can move between a locked position as illustrated in FIG. 1, and an unlocked position (not shown). In the locked position, the locking member 120 is securely engaged by the internal lock components in a conventional manner. The locking member 120 remains securely engaged with the internal lock components until a user manipulates the wheels 130 to a predetermined combination, thereby allowing the locking member 120 to move to the unlocked position. In the unlocked position, the locking member 120 is spaced apart from the body 110 to allow a user to attach the locking device 100 to other objects. In many embodiments the locking member 120 can be rigid or flexible. For example, in a specific embodiment the locking member 120 may be formed of a single rigid piece of metal, such as hardened steel. In other embodiments the locking member 120 can be a cable or chain that is flexible and does not retain a predetermined shape in order to accommodate larger or odd sized objects, such as a bicycle for example.

The body 110 may also include a combination position indicator 114 proximate to the wheels 130. In certain embodiments, the indicator 114 identifies to a user where to position the wheels 130 that have selected letters that correspond to the combination of the locking device 100. When the proper combination of the letters is positioned in alignment with the indicator 114, the locking member 120 can freely move between the locked and unlocked positions. In the illustrated embodiment, the locking device can be configured so that letters on the wheels 130 that correspond to the lock's combination spell one of the words in alignment with the indicator 114. In another embodiment, the lock combination does not need to correspond to a word spelled out by the letters on the wheels. Accordingly, the letters on the wheels can simultaneously spell multiple words when the device is locked.

The indicator 114 of the illustrated embodiment is positioned approximately in the middle portion of the body 110 to indicate where the lock combination, such as one of the words, will be displayed by the wheels 130. The device 100 may be configured such that the first word when positioned at the indicator 114 corresponds to the lock's combination. In this configuration, one or more other words will be displayed along another row of letters of the wheels 130, wherein that other row of letters will be offset from the indicator 114. In other embodiments, an indicator 116 may be larger, as shown by broken lines in FIG. 1, to indicate where to display multiple words necessary to open the lock. For example, the indicator 116 shows where to position the letters of the wheels 130 that form the word or words corresponding to the combination to unlock and open the device 100.

The wheels 130 of the illustrated embodiment are axially aligned with each other and with the body 110. Each of the wheels 130 includes a plurality of selected letters 134 positioned around the wheel 130. The wheels 130 of the illustrated embodiment each have ten letters evenly spaced around the circumference of the wheel. Other embodiments can have greater or fewer letters around the wheels 130. For example, wheels having greater than ten positions are capable of simultaneously displaying a greater number of words. In one embodiment, a wheel can also have one or more blank spaces instead of a letter. In another embodiment, a wheel can have a combination of letters, numbers, symbols and/or blank spaces disposed around the wheel.

In one embodiment, the letters, numbers, symbols and/or blank spaces on the wheels can be selected in accordance with the method described in U.S. Pat. No. 6,621,405. For example, the letters can be selected in a manner related to the highest positional frequency on each wheel in order to produce the greatest number of words. In one embodiment, wheels of a device is configured by identifying a list of words, and based upon the frequency of the letters and the positions of the letters making up those words, the letters to be used on each wheel can be identified. Once the letters for each wheel have been identified, the arrangement of each letter on each wheel is determined so that two or more selected words are simultaneously spelled by the wheels. In one embodiment, the arrangement of the letters on each wheel is selected so that each row of the letters simultaneously spell selected words.

The arrangement of the specific letters on the wheels can also be selected to insure that words from a specific “to be included” list of words, can be simultaneously spelled by the wheels. For example, the arrangement of letters on the wheels of a lock can specifically include selected promotional words directed to an anticipated market or customer for the lock. In another example, the arrangement of letters on the wheels of a travel lock can be selected to simultaneously spell the words PACK, SOON, BILL, TRIP, HEAT, LURE and MYNA. It is noted that the arrangement of the letters on this travel lock will also allow a user to spell other words on the lock by rotating the wheels to different positions. In another embodiment for a padlock, the arrangement of letters on the wheels can be selected to simultaneously spell the words TRAIN, SPELL, WORDS, BETTY, LASER DINO, FLOAT, and ANISE. In yet another embodiment for a bike lock, the arrangement of letters on the wheels can be selected to simultaneously spell the words TURN, FAST, BIKE, LOOP, PLAY, METL, and SHED. While the above examples provide sample lists of words that can be used for different categories of locks, one skilled in the art will understand that other lists of words can be used for the “to be included” list of words for a selected device.

In yet other embodiments, the letters, numbers, symbols and/or blank spaces can be selected using other methods or processes, so as to provide a plurality of wheels that can be arranged relative to each other so that the letters across two or more rows simultaneously spell two or more words. For example, in a first row 136a across the device 100, the wheels 130 are arranged so that the letters 134 spell the word “TRAIN,” and the letters 134 in a second row 136b spell the word “SPELL” across the device. One skilled in the art will appreciate that locks containing three, four, five or more wheels may be used to spell multiple words having three, four, five or more letters. It is noted that a row of letters can be a series of letters on different wheels adjacent to each other relative to the body in a horizontal orientation, a vertical orientation, or other selected orientation.

Embodiments of the device 100 can be configured to provide a textual combination to unlock the device 100 that is easy for a user to remember because the two or more words displayed across the wheels 130 can be related to each other. For example, a user or lock manufacturer may select a combination that provides two words relating to the same subject or interest, such as “TRAIN” and “STOPS,” or “PHONE” and “RINGS.” Related words can help the user to remember the textual combination to open the lock, while still providing sufficient security to prevent someone else from guessing the combination. In other embodiments, a user or manufacturer may wish select a combination that provides two or more unrelated words or seemingly unrelated words as a combination to unlock the device 100. For example, a user may select the words “ROADS” and “SWEET.” Although the words are seemingly unrelated, to a user each word may have individual significance to help the user remember and retain the words to open the device. Moreover, seemingly unrelated words provide increased security against unauthorized users who may attempt to open the lock. As a result, using two or more words as the combination to unlock the device 100 can provide an easier to remember combination with increased security.

In yet another embodiment, a manufacturer can select a combination that provides two or more words, wherein at least one of the words is specifically targeted to an end user. For example, the locking device 100 can be custom configured such that one or more of the words corresponding to an initial combination is a specifically requested word. Accordingly, a company can order custom locks that have an initial combination wherein the company name, such as WordLock, will be displayed in the rows across the wheels.

Other embodiments of the device 100 may prevent or exclude specific words from being displayed on the device 100. In some situations, a user may not want a lock that is capable of spelling objectionable words. For example, a parent may not want a child to use a combination lock capable of spelling objectionable, vulgar or obscene words, such as B*TCH, S*IT or D*MN. In one embodiment, the selection and arrangement of the letters on the wheels can also include a process of creating a list of excluded or forbidden words that can not be spelled by the letters as arranged on the wheels of the lock. Accordingly, one can specifically identify one or more excluded words and arrange the letters on the wheels so one or more of the letters required for the excluded words is not provided at the letter's required location for that word. As an example, if a swear word beginning with the letter “S” is included on the list of excluded words, the letters on the first wheel can be selected so that “S” is specifically excluded from that wheel. If, however, the exclusion of the letter “S” from the first wheel results in an unacceptable decrease in the number of potential words that could be spelled by the letters as arranged on the wheels, then a different letter of the forbidden word can be excluded from the wheel corresponding to that letter's location in the word. This way a manufacturer can control which words can be displayed by the lock and which words can be specifically excluded from being displayed by the lock.

In at least one embodiment, the lock device 100 is configured so the user can reset the combination of the lock device to unlock the device. The user can set or reset the lock's combination to be a word, including an acronym, abbreviation, or other term. Alternatively, the user can set the combination to be a sequence of letters that do not spell a word. Various mechanisms for resetting a combination lock are available and known in the art. Accordingly, resettable combinations are another feature of the textual based locking device that helps a user to remember the combination to open the lock.

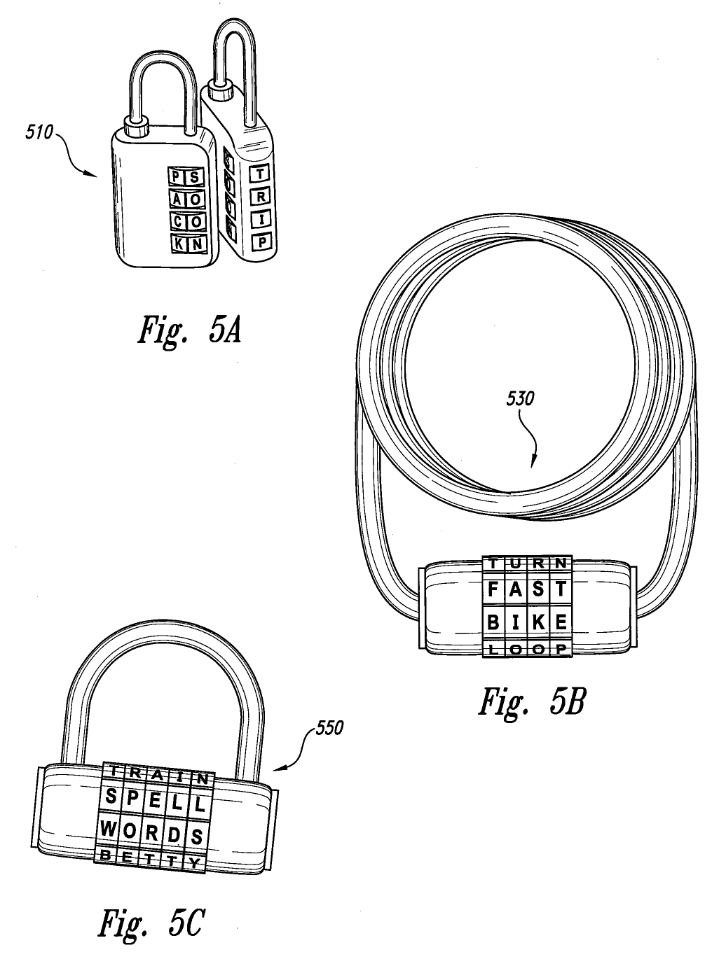

FIG. 2 is a block diagram of a representative table 200 illustrating letter positions of the wheels 210 in accordance with several embodiments of the invention. In one embodiment, the table 200 illustrates a locking device having four wheels 210 as shown by the wheel columns 210a-210d. Each wheel 210 has a plurality of letter positions 205 for displaying one letter in each letter position. Aligning the letter positions 205 of the wheels 210 simultaneously spells words in a plurality of rows 220. In one embodiment as shown in FIG. 5A-5C, the letters can be selected and arranged on the wheels so that words are simultaneously displayed in all of the rows on the wheels.

In one embodiment, the letter positions 205 can spell two or more words forming a phrase. For example, as shown by representative rows 220a and 220b, the rows form the phrase “TURN BIKE.” Moreover, as shown by representative rows 220a, 220b and 220c, rows can also form the phrase “TURN BIKE FAST.” The configuration of spelling a phrase rather than just related or unrelated words helps the user to better remember the combination. For example, a user who is interested in biking or using the locking device to secure a bicycle would likely appreciate and remember the phrase “TURN BIKE FAST” as the unlocking combination. In addition, other embodiments of the locking device can be configured to display words related to the intended purpose of the locking device. For example, a travel lock may be configured to display the words “PACK” and “SOON.”

In certain embodiments letters may or may not be repeated on one wheel so that every letter combination produces a unique alignment of the wheels. In addition, the letter arrangement on each wheel can be alphabetical or random, or could be arranged so that the lock shows a word for each of the ten or more positions for each wheel. For example, wheel 1 in FIG. 2 does not repeat a letter in the column displayed by wheel 1. However if the desired combination words for a lock having five wheels were WRIST and WATCH, “W” may be repeated on the first wheel. As noted above, letter selection and position on the wheels can be based on positional frequency to improve the number of words that can be displayed on the device.

In another embodiment illustrated in FIG. 2 by representative rows 220d and 220e in FIG. 2, the letter positions 205 spell two or more words in a language other than English. For example, the letters of row 220d can spell the word “VERT,” which means green in French, and the letters of row 220e can spell the word “AZUL,” which means blue in Spanish. The letters on the wheels can include characters specific to a selected language. For example, a wheel can include letters such as ü, á, ç and \check{n}, etc. It will be appreciated that the wheels can be configured with letters to spell words in a single language or in more than one language. For example, both words can be in French or one of the words can be in English and one of the words can be in a language other than English. Having the ability to spell words in languages other than English expands and varies the word choices for the user to set the combination. Providing words in languages other than English can also satisfy and relate to more potential users.

Furthermore, in another embodiment illustrated in FIG. 2 by representative rows 220f and 220g, the wheels 210 are configured with letters in selected letter positions 205 to allow a user to spell words that include acronyms, abbreviations, or other terms, rather than complete words. For the purposes of this disclosure, acronyms generally include selected letters taken from a word or series of words to provide an abbreviation for that word or series of words. For example, the wheels 210 can be configured with letters in the letter positions 205 arrangeable in a representative row 220f to spell the acronym “OTOH,” which is an abbreviation for “On The Other Hand.” Moreover, similar to the embodiments described above, the wheels 210 can be configured with letters in letter positions 205 to spell two or more acronyms. For example, the letter positions 205 of a representative row 220g can spell the acronym “ROFL,” which stands for “Rolling On Floor Laughing.”

In another embodiment, wheels 210 can be configured with letters in letter positions 205 to simultaneously spell one acronym in one row and a complete word in another row. In other embodiments, the wheels 210 can be configured with letters or a collection of letters and numbers that allow a user to select a lock combination that spells recognized or recognizable terms. For example, the letters on the wheels can be arranged to spell terms, such as Instant or Text Messaging acronyms or Text Messaging shorthand (e.g., the terms listed at the www.netlingo.com website). In one embodiment, a lock can be configured with wheels that can spell 4EVER (meaning “forever”), 2NITE (meaning “tonight”), and 14AA41 (meaning “one for all and all for one”), or other terms. In another embodiment, the wheels can be configured with letters and symbols so that a user can select a rebus. For example, a user could create a rebus, such as “I♡YOU” or “I♡2EAT” to be displayed by the wheels of the lock. The rebus can be configured so it is the combination for the lock. Providing the ability to spell words, including acronyms, abbreviations, terms, and/or rebuses, across the locking device 100 provides additional flexibility and variation of the available appearance of the lock and/or the combination to open the lock.

In still another embodiment illustrated in FIG. 2 as indicated above, the wheels 210 can be configured to display more than ten letter positions 205, as illustrated by Position 1, Position 2, . . . , Position n. As noted above, traditional tumbler or wheel-based numeric combination locks have wheels that typically only display or contain ten number positions (0-9). Eleven or more letter positions 205 provide the benefit of being able to display a greater number of words. A greater number of words can in turn provide greater flexibility in choosing the words to be displayed and/or to form the combination, thereby providing increased security because of the greater number of combinations to open the locking device.

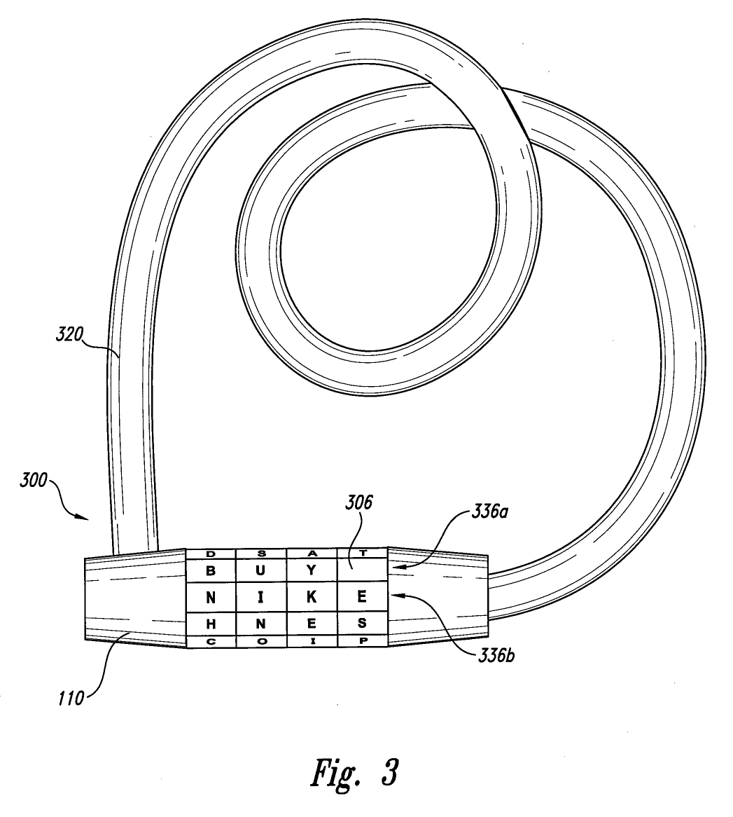

In yet another embodiment illustrated in FIG. 2, a representative row 220h can include a blank letter position 206, that can later receive a letter or remain blank. The table 200 can include more than one blank letter positions 206 and the blank letter position 206 can also be located in other rows or columns of the table 200. The blank letter position(s) 206 provides additional flexibility for selecting words for the unlocking combination. For example, in certain embodiments a manufacturer may initially leave a letter position blank and later print or imprint a letter on the blank space according to a user's preferences. In other embodiments, providing a blank letter space also provides the flexibility to display words having different numbers of letters. For example, as illustrated in FIG. 3, a combination locking device can display the words “BUY” and “NIKE.” Accordingly, providing word-based locks having blank spaces and words with different numbers of letters varies and increases the number of available words for the unlocking combination.

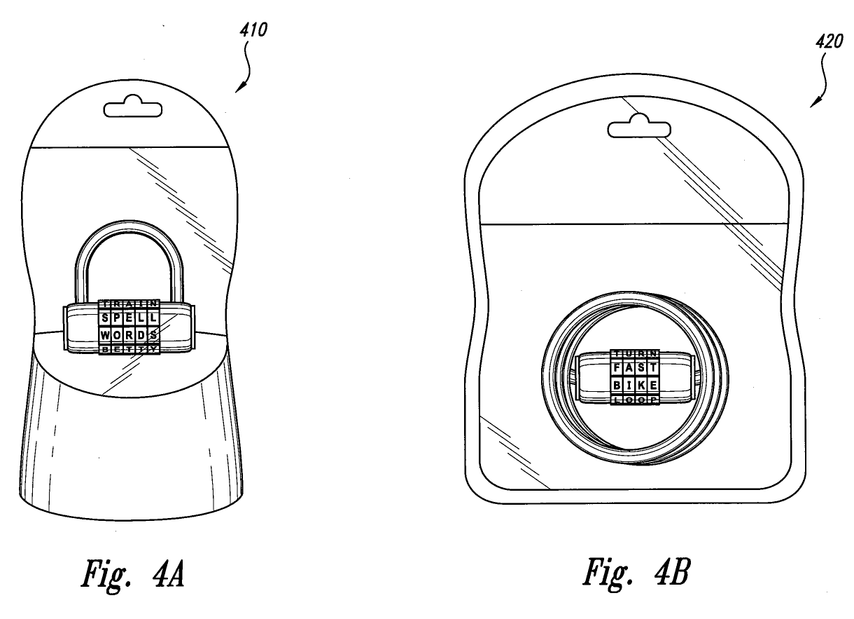

FIG. 3 is a schematic view of a text-based combination locking device 300 in accordance with another embodiment of the invention. In FIG. 3, similar reference characters are used to indicate similar features of the embodiments and will not be repeated. FIG. 3 includes a locking device 300 having a locking member 320 that is a flexible cable as described above in one embodiment of FIG. 1. The locking device 300 also includes a representative row 336a that includes a blank space 306. Moreover, row 336a along with another representative row 336b display the promotional words “BUY” and “NIKE.” Promotional words may include, but are not limited to, words or trademarks to market or advertise a particular brand. Locking devices with the capability of displaying promotional words or messages provide for another type of advertising and/or another way to distinguish the combination lock for users. For example, a retailer may want to display promotional words on the locking device while the device is displayed for sale. Accordingly, in at least one embodiment the promotional words would be included on the “to be included” list of words when determining the letters and arrangement of the letters on the wheels of a lock. FIGS. 4A and 4B illustrate embodiments of locking devices 410 and 420 in packaging appropriate for sale in a retail market. Accordingly, a locking device can be specifically packaged for sale in the wholesale or consumer retail market with selected promotional words (including acronyms, abbreviations, rebuses, or other terms) arranged across the wheels and visible to a potential purchaser.

FIGS. 5A-5C are schematic views of word based combination locking devices in accordance with embodiments of the invention. A word based travel lock 510, a word-based bicycle lock 530, and a word-based padlock 550 illustrate the varied use and function of some of the embodiments of word-based combination locks disclosed herein.

From the foregoing, it will be appreciated that specific embodiments of the invention have been described herein for purposed of illustration, but that various modifications may be made without deviating from the scope of the invention. Accordingly, the disclosure is not limited except as by the appended claims.

I/We claim:

1. A word-based combination lock device, comprising:
a body;
a locking mechanism coupled to the body; and
at least two wheels operatively coupled to the locking mechanism and to the body, each of the wheels being rotatable relative to the body between a locked position wherein the locking mechanism is locked relative to the respective wheel and an unlocked position wherein the locking mechanism is unlocked relative to the respective wheel, wherein each wheels displays two or more letters forming two or more rows of letters relative to the body, and wherein the letters on the wheels are configured to spell a first word displayed on a first row of letters and a second word displayed on a second row of letters.

2. The device of claim 1 wherein the letters on the wheels are configured to spell the first word displayed on the first row of letters and the second word displayed on the second row of letters when the wheels are in the unlocked position.

3. The device of claim 1 wherein each wheel is configured to display three or more letters forming three or more rows of letters relative to the body, and wherein the letters on the wheels are configured to spell three or more words.

4. The device of claim 1 wherein the first and second words together comprise a phrase.

5. The device of claim 1 wherein at least one of the first and second words is at least one of an acronym, abbreviation, rebus, and term.

6. The device of claim 1 wherein at least one of the first and second words defines a first combination corresponding to the unlocked position, and wherein the device can be reset to define a second combination corresponding to the unlocked position, wherein the second combination is different from the first combination.

7. The device of claim 1 wherein the first and second words are selected from a predetermined list of words that does not include a plurality of objectionable words.

8. The device of claim 7 wherein the objectionable words include at least one of swear words and vulgar words.

9. The device of claim 1 wherein the letters on the wheels are configured so the objectionable words cannot be displayed on the device.

10. The device of claim 1 wherein the letters on at least one of the wheels are selected for that wheel as a function of the frequency and location of letters in words in a first list of words, and the arrangement of the letters on the wheel is determined as a function of the location of letters in words in a second list of words.

11. The device of claim 10 wherein the letters on wheel are selected to exclude one or more letters from one or more words on a third list that define excluded words so the wheels can not be arranged to spell the one or more of the excluded words.

12. The device of claim 1 wherein the letters on wheel are selected to exclude one or more letters from one or more selected words so the wheels can not be arranged to spell the one or more of the excluded words.

13. The device of claim 1 wherein the two words comprise a common theme.

14. The device of claim 1 wherein at least one of the first and second words is a promotional word.

15. The device of claim 1 wherein at least one wheel includes at least one blank position not displaying a letter.

16. The device of claim 1 wherein the first word displayed on the first row of letters is not adjacent to the second word displayed on the second row of letters.

17. The device of claim 16, further comprising a position indicator, wherein the position indicator designates where to display the first or second words relative to the body to unlock the locking mechanism.

18. The device of claim 1 wherein the wheels are configured so at least one of the first and second words is a promotional word.

19. A word based combination lock device, comprising:
a body;
a locking mechanism operatively coupled to the body; and
a plurality of wheels operatively coupled to the locking mechanism and to the body, each of the wheels having a plurality of letters arrangeable to form two or more rows of letters relative to the body, wherein the wheels are rotatable relative to the locking mechanism in a locked position and an unlocked position, and wherein the letters are arranged to spell at least two words in the two or more rows, and wherein at least one of the two or more words is a word in a language other than English.

20. The device of claim 19 wherein the letters are arranged to spell one or more words in at least one of Spanish, French, German, Italian and Latin when the wheels are in the unlocked position.

21. The device of claim 19 wherein the letters are configured to spell at least two words in different languages when the wheels are in the unlocked position.

22. The device of claim 19 wherein the plurality of letters include letters from two or more different alphabets.

23. The device of claim 19 wherein the wheels are arrangeable to the letters on the wheels simultaneously spell at least two words in the two or more rows when the wheels are in the unlocked position,

24. The device of claim 19 wherein at least one of the first and second words defines a combination corresponding to the unlocked position, and wherein the device can be reconfigured to define a second combination corresponding to the unlocked position, wherein the second combination is different from the first combination.

25. The device of claim 19 wherein the first and second words are selected from a predetermined list of words that does not include a plurality of objectionable words.

26. The device of claim 19 wherein the letters on at least one of the wheels are selected for that wheel as a function of the frequency and location of letters in words in a first list of words, and the arrangement of the letters on the wheel is determined as a function of the location of letters in words in a second list of words.

27. The device of claim 26 wherein the letters on wheel are selected to exclude one or more letters from one or more words on a third list that define excluded words so the wheels can not be arranged to spell the one or more of the excluded words.

28. The device of claim 19 wherein the letters on wheel are selected to exclude one or more letters from one or more selected words so the wheels can not be arranged to spell the one or more of the excluded words.

29. A method of manufacturing a word-based combination locking device, the method comprising:
selecting a plurality of words to be displayed by the device;
disposing a plurality of rotatable wheels at least partially within the device, wherein the wheels display a plurality of letters configured to spell words across the device; and
arranging the plurality of wheels in a first position, wherein in the first position the wheels simultaneously display two or more of the plurality of words.

30. The method of claim 29 wherein arranging the plurality of wheels include arranging the plurality of wheels in the first position that corresponds to an unlocked position of the device.

31. The method of claim 29 wherein the wheels display at least one of an acronym, abbreviation, rebus, and other term in the first position.

32. The method of claim 29 wherein at least one of the two or more words displayed by the wheels in the first position is a word in a language other than English.

33. The method of claim 29 wherein the wheels can be reset to display a second combination corresponding to the first position, wherein the second combination differs from the first combination.

34. The method of claim 29, further comprising packaging the word-based combination locking device so at least two or more words are simultaneously displayed and visible to a person looking at the packaging.

35. The method of claim 29, further comprising identifying a first list of word, selecting the letters to be displayed on at least one wheel as a function of the frequency of letters in the words in the first list of words, determining a second list of words that is a subset of the first list of words, and arranging of the letters on the at least one wheel as a function of the location of the letters in the words in the second list of words so the words on the second list of words can be spelled simultaneously spelled by the letters on the wheels.

36. The device of claim 35, further comprising identifying a list of excluded words, and arranging the letters on the at least one wheel to exclude one or more letters from the excluded words so the wheels can not be arranged to spell the one or more excluded words.
